(19) United States
(12) Patent Application Publication
(10) Pub. No.: US 2011/0233806 A1
(43) Pub. Date: Sep. 29, 2011

(54) METHOD FOR MANUFACTURING VEHICLE LIGHTING PART

(76) Inventors: Tatsuya Umeyama, Yokohama-shi (JP); Shintaro Hirabayashi, Hadano-shi (JP)

(21) Appl. No.: 13/049,615

(22) Filed: Mar. 16, 2011

(30) Foreign Application Priority Data
Mar. 24, 2010 (JP) 2010-067266

(51) Int. Cl. B29C 44/02; B29C 44/34

(52) U.S. Cl. 264/50

(57) ABSTRACT

A method for manufacturing a vehicle lighting part in accordance with principles of the presently disclosed subject matter can include using a mold including a fixed section, a movable section, and a core section to slide according to a movement of the movable section, and an injection molding unit. The exemplary method can also include putting a first mixture of the molding compound and a chemical foaming agent into the injection molding unit, the molding compound containing polypropylene series resin to which a predetermined amount of talc is added. The method can also include producing a second mixture by enclosing a physical foaming agent in the first mixture in the injection molding unit. Finally, the exemplary method can include injecting the second mixture from the injection molding unit into the mold to fill the mold, and performing a core back of the core section immediately after injecting the second mixture into the mold to fill the mold.

### BACKGROUND

This application claims the priority benefit under 35 U.S.C. §119 of Japanese Patent Application No. 2010-067266 filed on Mar. 24, 2010, which is hereby incorporated in its entirety by reference.

1. Field

The presently disclosed subject matter relates to a method for manufacturing a lighting part, and particularly to a resin molding method suitable for manufacturing a vehicle lighting part.

2. Description of Related Art

In recent years, there has been a strong request for reducing weight of an automotive or vehicle part (in particular, an exterior part) including an vehicle lighting part so that an automobile may get good mileage. For this purpose, a foam-molded article has begun to be used as an exterior part. In order to realize further weight reduction of an automobile or other vehicle, there is a demand for using a smaller amount of resin and acquiring a molded article which performs as well as a conventional article. Therefore, an injection-foam-molded article, the expansion ratio of which is further increased, has been strongly demanded.

Foaming technology for resin-molded article includes the following two methods; one is a method of putting a chemical foaming agent, such as polystyrene or sodium hydrogen carbonate, into resin material in advance; the other is a method of enclosing (feeding under pressure) a physical foaming agent, such as nitrogen or carbon dioxide, in resin material before being molded.

Japanese Patent Application Laid-Open Publication No. 2008-142997 discloses a technique for weight reduction in which both a chemical foaming agent and a physical foaming agent are used. This document describes, in particular, that the technique makes it possible to provide a molded article which has a good appearance even if the thickness of a resin-molded article is small.

However, the technique described in Japanese Patent Application Laid-Open Publication No. 2008-142997 is directed to a vehicle interior part and focuses on an appearance of the vehicle interior part. That is, the technique is not directed to an exterior part, such as a vehicle lighting part, for which a certain degree of rigidity is required. Therefore, although the weight of an exterior part can be reduced when the exterior part is molded by using both a chemical foaming agent and a physical foaming agent, the exterior part may not maintain the rigidity required for an exterior part.

### SUMMARY

Therefore, one aspect of the presently disclosed subject matter is to provide a method for manufacturing a vehicle lighting part which enables weight reduction of an exterior part, with the exterior part maintaining rigidity required for an exterior part.

According to another aspect of the presently disclosed subject matter , there is provided a method for manufacturing a vehicle lighting part, the method using a mold including a fixed section, a movable section, and a core section to slide according to a movement of the movable section; and an injection molding unit to inject a predetermined molding compound into the mold; the method including the steps of: putting a first mixture of the molding compound and a chemical foaming agent into the injection molding unit, the molding compound containing polypropylene series resin to which a predetermined amount of talc is added; producing a second mixture by enclosing a physical foaming agent in the first mixture in the injection molding unit; injecting the second mixture from the injection molding unit into the mold to fill the mold; and performing a core back of the core section immediately after injecting the second mixture into the mold to fill the mold.

### BRIEF DESCRIPTION OF THE DRAWINGS

The above and other advantages and features of the presently disclosed subject matter will become more fully understood from the detailed description given hereinbelow and the appended drawings which are given by way of illustration only, and thus are not intended as a definition of the limits of the presently disclosed subject matter, and wherein:

FIG. 1 is a perspective view showing an outline configuration of a vehicle lighting part;

FIG. 2 is a bottom view of FIG. 1;

FIGS. 3A to 3D are pattern diagrams to schematically illustrate a method for molding resin for the vehicle lighting part;

FIGS. 4A to 4E are diagrams schematically showing a structure and a motion of a mold;

FIGS. 5A to 5C are diagrams to schematically illustrate a state of a core back of the mold;

FIGS. 6A to 6D are diagrams to schematically illustrate a configuration of the mold and a principle of experiments in an embodiment of the presently disclosed subject matter;

FIG. 7 is a table showing measurement results of shapes and weight reduction ratios of molded articles formed under various conditions;

FIG. 8 is a table showing measurement results of shapes and weight reduction ratios of molded articles with various original thicknesses and core back amounts; and

FIG. 9 is a table showing measurement results of flexural strength and flexural moduli of molded articles with or without talc.

### DESCRIPTION OF EXEMPLARY EMBODIMENTS

In the following, an exemplary embodiment according to the presently disclosed subject matter is described with reference to the drawings.

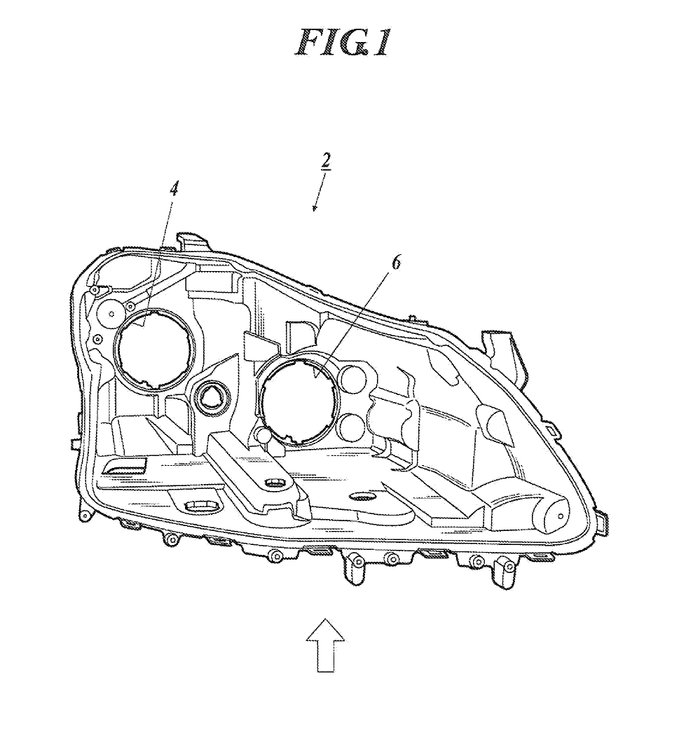

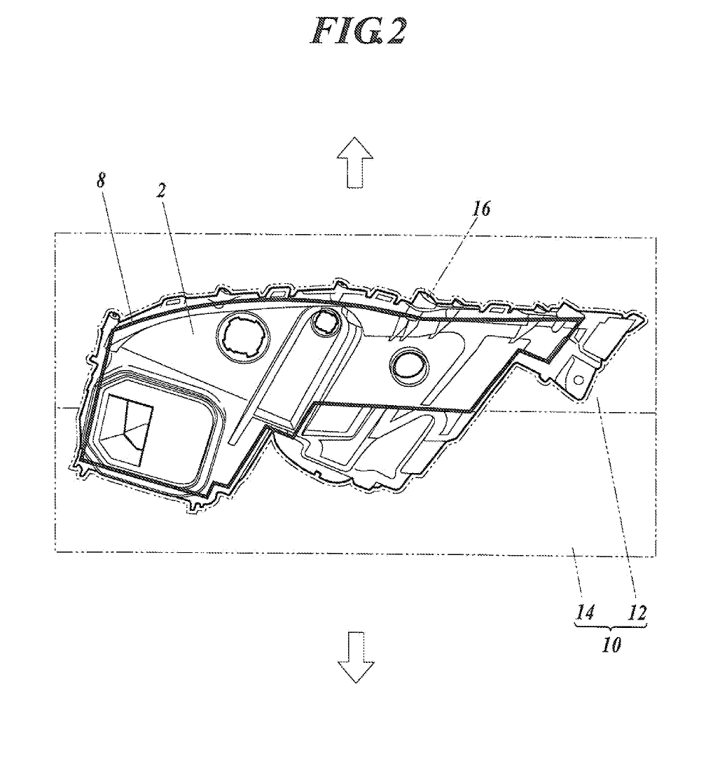

As shown in FIG. 1, a vehicle lighting part 2 can include a housing to cover a light source such as a bulb. Bulbs, shielding hoods, a reflector, and the like (not shown) can be arranged inside the vehicle lighting part 2 and a lens cover and the like (not shown) is attached to the surface of the vehicle lighting part 2. Two through-holes 4 and 6 can be formed on the vehicle lighting part 2, and the bulbs are inserted into the through-holes 4 and 6. The vehicle lighting part 2 has an appearance shown in FIG. 2 when it is viewed from the bottom (in the direction of the arrow in FIG. 1).

In manufacturing the vehicle lighting part 2, a mold 10 composed of a fixed mold 12 (a fixed section) and a movable mold 14 (a movable section) can be used, as shown by the chain double-dashed lines in FIG. 2. When the mold 10 is clamped, a cavity 16 (molding space) is formed between the fixed mold 12 and the movable mold 14. In general terms, a predetermined resin material is injected into the cavity 16 to fill the cavity 16, and then, when the mold 10 is opened in the direction of the arrows in FIG. 2 after the cure of the resin material, the vehicle lighting part 2 is manufactured as a molded article.

As shown by the thick lines in FIG. 2, the vehicle lighting part 2 can include an undercut portion 8 (a portion, the shape and the position of which obstructs the opening (parting) of the mold 10 in the direction of the arrows in FIG. 2). For molding the undercut portion 8, a core mold, which is a mold other than the fixed mold 12 and the movable mold 14, can be used.

Next, the manufacturing method for the vehicle lighting part 2 (resin molding method) is described in detail.

The exemplary method is mainly composed of steps (S1) to (S5) described as follows.

(S1) putting a mixture (a first mixture) of a molding compound and a chemical foaming agent into an injection molding unit
(S2) producing a mixture (a second mixture) by enclosing a physical foaming agent in the mixture produced in step (S1).
(S3) injecting the mixture, in which the physical foaming agent is enclosed in step (S2), into the mold to fill the mold
(S4) performing a core back of the mold immediately after injecting the mixture to fill the mold in step (S3)
(S5) cooling the mold to cure the molding compound and opening the mold.

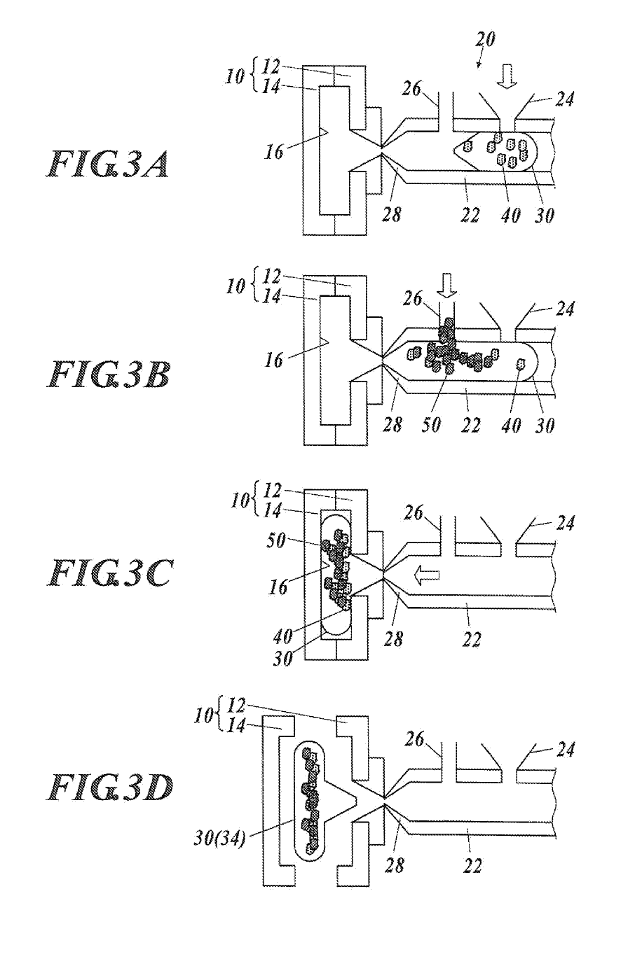

In this exemplary method, the mold 10 and an injection molding unit 20 are used, as shown in FIG. 3. The injection molding unit 20 has a cylinder 22, to which a hopper 24 (a material inlet) and a gas inlet 26 are joined. A nozzle 28 in the tip portion of the cylinder 22 is joined to a sprue of the mold 10 (the fixed mold 12).

In the step of (S1), a molding compound 30 is put into the cylinder 22 from the hopper 24 as shown in FIG. 3A. The molding compound 30 contains a chemical foaming agent 40.

As the molding compound 30, a mixture containing commonly-known thermoplastic resin as a major component, and a predetermined amount of talc added therein, can be used. As the thermoplastic resin, polypropylene series resin can be used. The additive amount of talc can be 30% (percentage by weight) of the overall weight of the mixture. By adding the predetermined amount of talc to the molding compound 30, a molded article 34, which has the rigidity required for the vehicle lighting part 2, is manufactured. As the chemical foaming agent 40, a commonly-known chemical foaming agent, which can be polystyrene, can be used.

In the step of (S2), a physical foaming agent 50 is enclosed (fed under pressure) in the molding compound 30 from the gas inlet 26, while the molding compound 30 in the cylinder 22 is melted and mixed, as shown in FIG. 3B.

As the physical foaming agent 50, a commonly-known physical foaming agent, which can be nitrogen, carbon dioxide, or the like, can be used. When nitrogen is used as the physical foaming agent 50, nitrogen in a supercritical state can be fed under pressure.

In the step of (S3), the molding compound 30, which contains the chemical foaming agent 40 and the physical foaming agent 50, is injected from the nozzle 28 of the cylinder 22 into the cavity 16 of the mold 10, to fill the mold 10 as shown in FIG. 3C.

Although the length of time for which the molding compound 30 is injected (the length of time for which the mold 10 is filled with the molding compound 30) can be suitably changed depending on the kind of resin, the temperature of the mold 10, or the like, it is preferable to make the time short; preferably the time is within 1.1 seconds, and more preferably within 0.85 seconds.

When the cavity 16 of the mold 10 is filled with the molding compound 30, the chemical foaming agent 40 and the physical foaming agent 50 in the molding compound 30 foam in the cavity 16. When the length of time for which the molding compound 30 is injected is short, as previously mentioned, the foaming of the chemical foaming agent 40 and the physical foaming agent 50 is encouraged.

In the step of (S4), a core back of the mold 10 is performed to encourage the foaming of the chemical foaming agent 40 and the physical foaming agent 50.

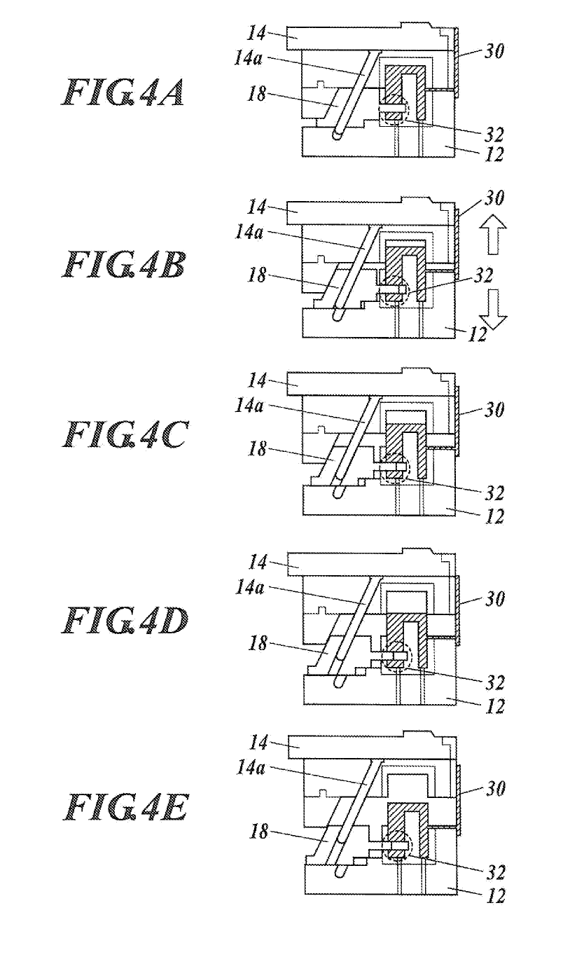

The step (S4) is described as follows in detail with reference to FIG. 4A. A core mold 18 (a core section) is provided between the fixed mold 12 and the movable mold 14. The movable mold 14 is provided with an angular pin 14a. The core mold 18 has a hole into which the angular pin 14a is inserted at an angle to the core mold 18. A part of the core mold 18 protrudes into the fixed mold 12, so that an undercut portion 32 is formed with the molding compound 30 which fills the cavity 16. The undercut portion 32 is a portion which corresponds to the undercut portion 8 of the vehicle lighting part 2. More specifically, the undercut portion 32 is a portion which is formed into the undercut portion 8 after the cure of resin.

As shown in FIG. 4B, when the movable mold 14 is moved away from the fixed mold 12, the angular pin 14a is moved in the same direction as the movable mold 14 (the direction of the up-pointing arrow in FIG. 4B), with the angular pin 14a sliding on the inner surface of the hole of the core mold 18. With the movement of the movable mold 14, the core mold 18 slides in the direction almost perpendicular to the direction of the movement of the movable mold 14 (the core mold 18 slides in the left-hand direction in FIG. 4B). After that, when the movable mold 14 is moved further away from the fixed mold 12, the core mold 18 is pulled away from the fixed mold 12 with the movement of the angular pin 14a, and thereby, the undercut portion 32 is formed, as shown in FIGS. 4C to 4E.

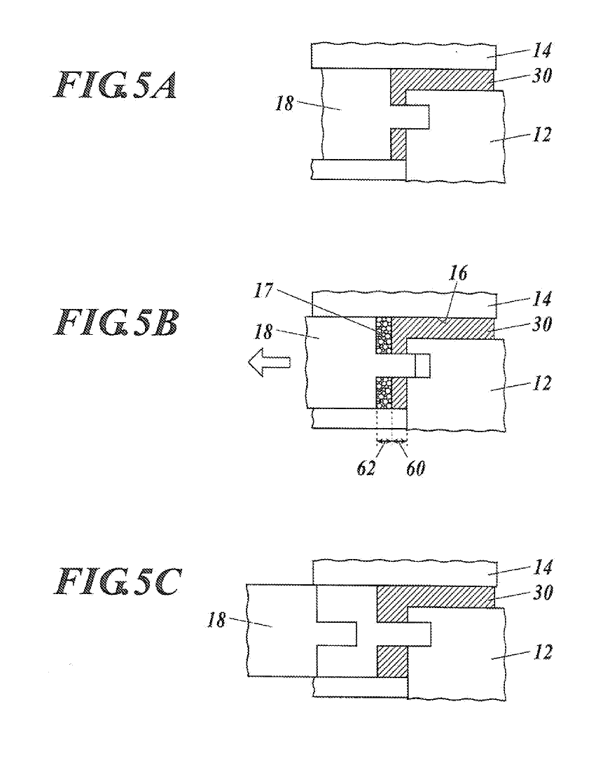

In the following, the neighborhood state of the undercut portion 32 is described in more detail. In the state before the movable mold 14 is moved, the part of the core mold 18 protrudes into the fixed mold 12, as shown in FIG. 5A.

In the step of (S4), a core back of the core mold 18 is performed with the movement of the movable mold 14, and a foaming space 17 (a gap portion) is formed between the molding compound 30, which fills the cavity 16, and the core mold 18, to form the space to encourage the foaming of the chemical foaming agent 40 and the physical foaming agent 50 in the molding compound 30, as shown in FIG. 5B. That is to say, the formation of the foaming space 17 causes the internal pressure inside the mold 10 to be lowered, and thereby, encourages the foaming of the chemical foaming agent 40 and the physical foaming agent 50.

A core back amount 62 (an amount of movement) of the core mold 18 can be about 50 to 66% of an original thickness 60 (the thickness of the molding compound 30 before a core back).

Then, the movable mold 14 is moved farther to move the core mold 18 away from the fixed mold 12, and thereby, the undercut portion 32 is formed, as shown in FIG. 5C.

In the steps of (S3) to (S4), the temperature of the movable mold 14 and the temperature of the core mold 18 are set to be higher than the temperature of the fixed mold 12. When polypropylene resin is used as a major component of the molding compound 30, the temperature of the movable mold 14 and the temperature of the core mold 18 can be set to equal to or more than 100° C., and the temperature of the fixed mold 12 can be set to 30 to 60° C.

When the temperature of the movable mold 14 and the temperature of the core mold 18 are set to be higher than the temperature of the fixed mold 12, the viscosity of the resin around the movable mold 14 and the core mold 18 in the molding compound 30 is lowered, which encourages the foaming of the chemical foaming agent 40 and the physical foaming agent 50.

In the step of (S5), the mold 10 is cooled to cure the molding compound 30, and then, the movable mold 14 is moved away from the fixed mold 12 (the mold 10 is opened) , so that the molded article 34 is obtained, as shown in FIG. 3D. Thus, the vehicle lighting part 2 which includes the undercut portion 8 is manufactured.

According to the exemplary manufacturing method for the vehicle lighting part 2 described above, the vehicle lighting part 2 can maintain an amount of rigidity required for an exterior part, because the material containing the polypropylene series resin, to which the predetermined amount of talc is added, is used as the molding compound 30. Moreover, the expansion ratio of the chemical foaming agent 40 and the physical foaming agent 50 is increased, and thereby, the weight of the vehicle lighting part 2 is reduced, because both the chemical foaming agent 40 and the physical foaming agent 50 are used and because the core back of the core mold 18 of the mold 10 is performed immediately after the mold 10 is filled with the mixture injected thereto, in the steps of (S3) to (S4).

As described above, the weight of the vehicle lighting part 2 is reduced while the vehicle lighting part 2 maintains rigidity required for an exterior part.

### EXAMPLE

(1) Manufacturing of Samples

(1.1) Molds and Molding Compound To Be Used

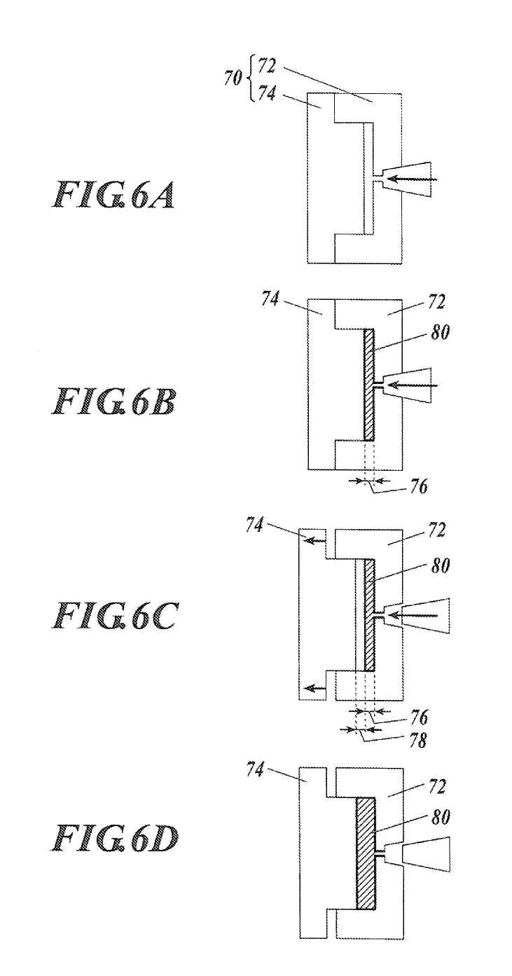

A mold 70 having the size of 300 mm×800 mm×180 mm to form molded articles, the thicknesses of which were 2 mm, 3 mm, and 5 mm, was used (See FIGS. 6A and 6B.). The mold 70 was composed of a fixed mold 72 and a movable mold 74. When the movable mold 74 was moved, a gap (a cavity) between the fixed mold 72 and the movable mold 74 was formed. On the other hand, as a molding compound 80 (See FIG. 6B.), a mixture containing polypropylene series resin (glass-transition temperature (Tg): −20° C., melting point (Tm) : 170° C.), to which talc was added, was used. The additive amount of talc was 30% (percentage by weight) of the overall weight of the mixture.

(1.2) Molding Method

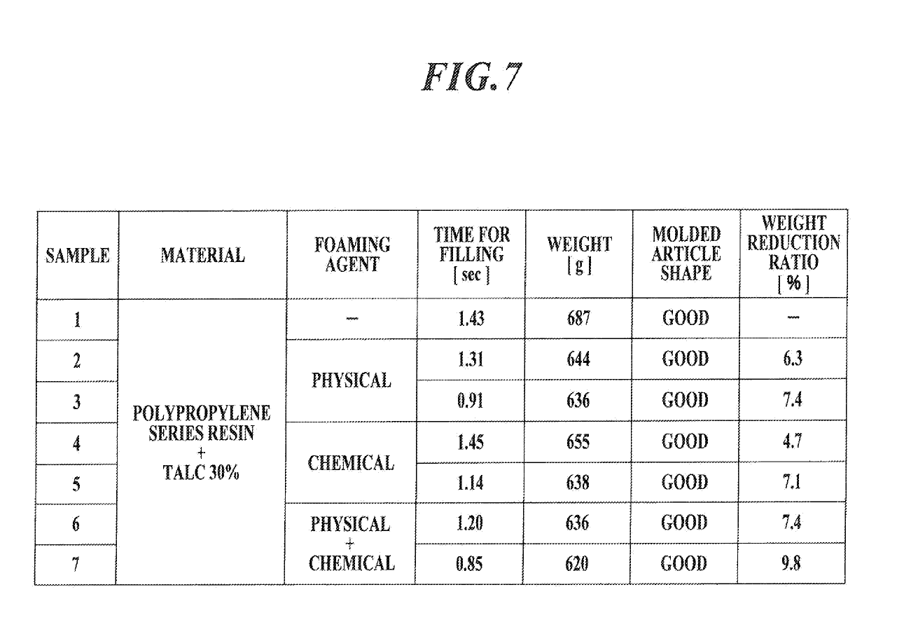

The molding compound 80 was injected into the mold 70 to manufacture a molded article having a thickness of 2 mm, by using a molding machine (MD8505S-IV, manufactured by Niigata Machine Techno Co., Ltd.). In this case, whether to use at least one of a physical foaming agent and a chemical foaming agent or not, the length of time for which the molding compound 80 was injected (the length of time for which the mold 70 was filled with the molding compound 80), and the like, were set as shown in the table in FIG. 7. The molded articles which were manufactured according to these settings are referred to as “samples 1 to 7”.

As the physical foaming agent, carbon dioxide (fill pressure: 5.5 MPa) was used.

As the chemical foaming agent, polystyrene (EE25C, manufactured by Eiwa Chemical Ind. Co., Ltd., 2 wt % (percentage by weight)) was used.

The major molding conditions other than the above were set as follows.

Injection speed: 30 to 150 mm/s

Resin temperature: 220 to 240° C.

(2) Assessment of Samples

(2.1) Measurement of Shapes of Molded Articles

The shape of the molded article of each of samples 1 to 7 was measured. The measurement results are shown in the table in FIG. 7.

In the table in FIG. 7, the criterion for good/poor is set as follows.

“good” . . . A shape according to the measurement of the mold is maintained.

“poor” . . . A shape according to the measurement of the mold is not maintained.

(2.2) Measurement of Weight Reduction Ratios

The weight reduction ratio (%) of the molded article of each of samples 1 to 7 was calculated, based on the following math formula (1). The results of the calculations are shown in the table in FIG. 7.

Math Formula (1): “weight reduction ratio (%)”=[(weight of molded article without foaming agent)−(weight of molded article with foaming agent)]/(weight of molded article without foaming agent)×100

In the formula (1), “weight of molded article without foaming agent” means the weight of sample 1, and “weight of molded article with foaming agent” means the weight of each of samples 2 to 7.

(2.3) Conclusion

As shown in the table in FIG. 7, the shape of the molded article was maintained according to the measurement of the mold 70 in any case of samples 1 to 7. Among samples 1 to 7, the weight reduction ratios of samples 2 to 5, for which either the physical foaming agent or the chemical foaming agent was used, were only 4.7 to 7.4%. On the other hand, the weight reduction ratios of samples 6 and 7, for which both of the physical foaming agent and the chemical foaming agent were used, were high level. In particular, the weight reduction ratio of sample 7, for which the length of time of injecting the molding compound 80 was shortened, was remarkably improved, the weight reduction ratio of sample 7 being as high as around 10%.

These results shows that a shape of a molded article is prevented from changing even if both a physical foaming agent and a chemical foaming agent are used, while weight reduction of the molded article is realized.

(3) Consideration of Optimum Conditions for Core Back Amount

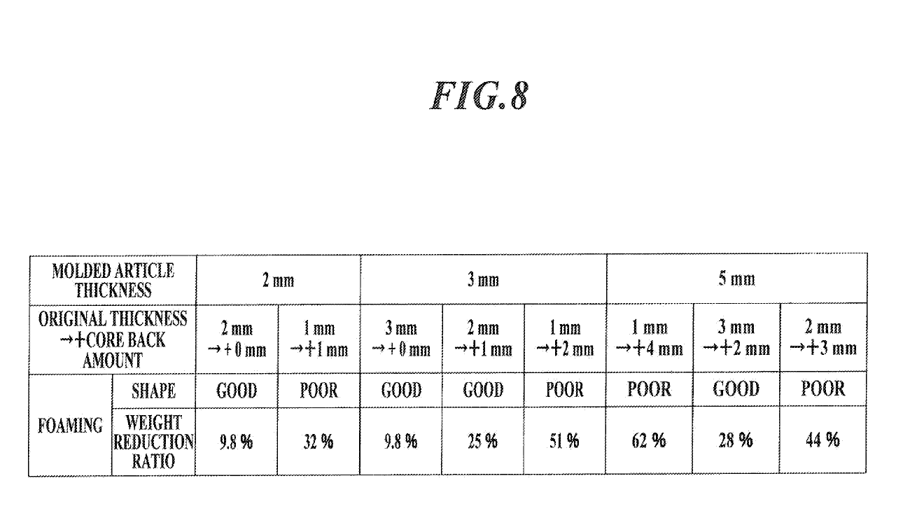

Under the molding conditions in the case of manufacturing sample 7, molded articles having thicknesses of 2 mm, 3 mm, and 5 mm, were manufactured, with a core back amount of the mold 70 being changed as shown in the table in FIG. 8. More specifically, the thickness of the molding compound 80, after being injected to fill the mold 70, was set as an original thickness 76, and the original thickness 76 and a core back amount 78 were respectively changed as shown in FIGS. 6B, 6C and 7. Thus, a molded article was formed, the thickness of the molded article being a sum of the original thickness 76 and the core back amount 78, as shown in FIG. 6D. In the same manner described in the above items (2.1) and (2.2), the shape and the weight reduction ratio of each molded article was measured. The results are shown in the table in FIG. 8.

In addition, the temperature of the fixed mold 72 was set to 50° C. and the temperature of the movable mold 74 was set to 100° C. in the mold 70.

As shown in the table in FIG. 8, additional weight reduction of a molded article was realized while preventing a shape of the molded article from changing in the following cases: the case where the original thickness 76 was 2 mm and the core back amount 78 was 1 mm, to obtain a molded article having a thickness of 3 mm (the case where the core back amount 78 was 50% of the original thickness 76); and the case where the original thickness 76 was 3 mm and the core back amount 78 was 2 mm, to obtain a molded article having a thickness of 5 mm (the case where the core back amount 78 was 66% of the original thickness 76).

(4) Test for Rigidity

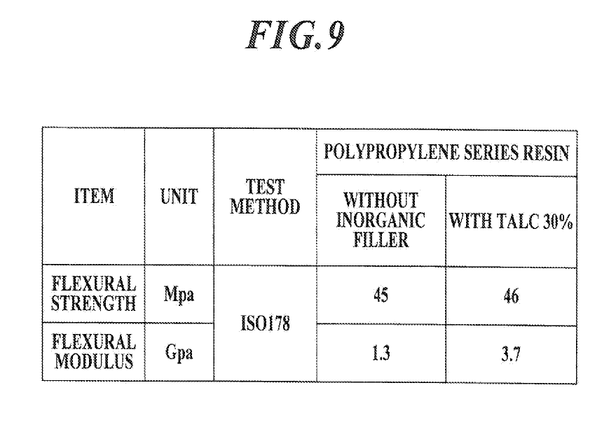

A flexural strength and a flexural modulus were measured using the molded article having a thickness of 3 mm in the case where the original thickness 76 was 2 mm and the core back amount 78 was 1 mm (the case where the core back amount 78 was 50% of the original thickness 76) in abovementioned item (3). The results are shown in the table in FIG. 9.

The results in the table in FIG. 9 shows that a molded article has rigidity required for a vehicle lighting part when a predetermined amount of talc is added to a molding compound, even if the weight reduction of the molded article is realized by putting both a chemical foaming agent and a physical foaming agent into the molding compound to be injected to fill a mold, and performing a predetermined core back.

According to an aspect of one exemplary embodiment of the presently disclosed subject matter, there is provided a method for manufacturing an vehicle lighting part 2, the method using a mold 10 including a fixed mold 12, a movable mold 14, and a core mold 18 to slide according to a movement of the movable mold 14; and an injection molding unit 20 to inject a predetermined molding compound 30 into the mold 10; the method including the steps of: putting a first mixture of the molding compound 30 and a chemical foaming agent 40 into the injection molding unit 20, the molding compound 30 containing polypropylene series resin to which a predetermined amount of talc is added; producing a second mixture by enclosing a physical foaming agent 50 in the first mixture in the injection molding unit 20; injecting the second mixture from the injection molding unit 20 into the mold 10 to fill the mold 10; and performing a core back of the core mold 18 immediately after injecting the second mixture into the mold 10 to fill the mold 10.

According to the presently disclosed subject matter , the weight of a vehicle lighting part is reduced while maintaining rigidity, which is required for an exterior part, of the vehicle lighting part, because both a chemical foaming agent and a physical foaming agent are used, a core back of a core mold of a mold is performed, and a material containing polypropylene series resin, to which talc is added, is used as a molding compound.

The entire disclosure of Japanese Patent Application No. 2010-067266 filed on Mar. 24, 2010 including description, claims, drawings, and abstract are incorporated herein by reference in its entirety.

Although various exemplary embodiments have been shown and described, the disclosed subject matter is not limited to the embodiments shown. Therefore, the scope of the invention is intended to be limited solely by the scope of the claims that follow.

(2.2) Measurement of Weight Reduction Ratios

The weight reduction ratio (%) of the molded article of each of samples 1 to 7 was calculated, based on the following math formula (1). The results of the calculations are shown in the table in FIG. 7.

Math Formula (1): “weight reduction ratio (%)”=[(weight of molded article without foaming agent)−(weight of molded article with foaming agent)]/(weight of molded article without foaming agent)×100

In the formula (1), “weight of molded article without foaming agent” means the weight of sample 1, and “weight of molded article with foaming agent” means the weight of each of samples 2 to 7.

(2.3) Conclusion

As shown in the table in FIG. 7, the shape of the molded article was maintained according to the measurement of the mold 70 in any case of samples 1 to 7. Among samples 1 to 7, the weight reduction ratios of samples 2 to 5, for which either the physical foaming agent or the chemical foaming agent was used, were only 4.7 to 7.4%. On the other hand, the weight reduction ratios of samples 6 and 7, for which both of the physical foaming agent and the chemical foaming agent were used, were high level. In particular, the weight reduction ratio of sample 7, for which the length of time of injecting the molding compound 80 was shortened, was remarkably improved, the weight reduction ratio of sample 7 being as high as around 10%.

These results shows that a shape of a molded article is prevented from changing even if both a physical foaming agent and a chemical foaming agent are used, while weight reduction of the molded article is realized.

(3) Consideration of Optimum Conditions for Core Back Amount

Under the molding conditions in the case of manufacturing sample 7, molded articles having thicknesses of 2 mm, 3 mm, and 5 mm, were manufactured, with a core back amount of the mold 70 being changed as shown in the table in FIG. 8. More specifically, the thickness of the molding compound 80, after being injected to fill the mold 70, was set as an original thickness 76, and the original thickness 76 and a core back amount 78 were respectively changed as shown in FIGS. 6B, 6C and 7. Thus, a molded article was formed, the thickness of the molded article being a sum of the original thickness 76 and the core back amount 78, as shown in FIG. 6D. In the same manner described in the above items (2.1) and (2.2), the shape and the weight reduction ratio of each molded article was measured. The results are shown in the table in FIG. 8.

In addition, the temperature of the fixed mold 72 was set to 50° C. and the temperature of the movable mold 74 was set to 100° C. in the mold 70.

As shown in the table in FIG. 8, additional weight reduction of a molded article was realized while preventing a shape of the molded article from changing in the following cases: the case where the original thickness 76 was 2 mm and the core back amount 78 was 1 mm, to obtain a molded article having a thickness of 3 mm (the case where the core back amount 78 was 50% of the original thickness 76); and the case where the original thickness 76 was 3 mm and the core back amount 78 was 2 mm, to obtain a molded article having a thickness of 5 mm (the case where the core back amount 78 was 66% of the original thickness 76).

(4) Test for Rigidity

A flexural strength and a flexural modulus were measured using the molded article having a thickness of 3 mm in the case where the original thickness 76 was 2 mm and the core back amount 78 was 1 mm (the case where the core back amount 78 was 50% of the original thickness 76) in abovementioned item (3). The results are shown in the table in FIG. 9.

The results in the table in FIG. 9 shows that a molded article has rigidity required for a vehicle lighting part when a predetermined amount of talc is added to a molding compound, even if the weight reduction of the molded article is realized by putting both a chemical foaming agent and a physical foaming agent into the molding compound to be injected to fill a mold, and performing a predetermined core back.

According to an aspect of one exemplary embodiment of the presently disclosed subject matter, there is provided a method for manufacturing an vehicle lighting part 2, the method using a mold 10 including a fixed mold 12, a movable mold 14, and a core mold 18 to slide according to a movement of the movable mold 14; and an injection molding unit 20 to inject a predetermined molding compound 30 into the mold 10; the method including the steps of: putting a first mixture of the molding compound 30 and a chemical foaming agent 40 into the injection molding unit 20, the molding compound 30 containing polypropylene series resin to which a predetermined amount of talc is added; producing a second mixture by enclosing a physical foaming agent 50 in the first mixture in the injection molding unit 20; injecting the second mixture from the injection molding unit 20 into the mold 10 to fill the mold 10; and performing a core back of the core mold 18 immediately after injecting the second mixture into the mold 10 to fill the mold 10.

According to the presently disclosed subject matter, the weight of vechicle lighting part is reduced while maintaining rigidity, which is required for an exterior part, of the vehicle lighting part, because both a chemical foaming agent and a physical foaming agent are used, a core back of a core mold of a mold is performed, and a material containing polypropylene series resin, to which talc is added, is used as a molding compound.

The entire disclosure of Japanese Patent Application No. 2010-067266 filed on Mar. 24, 2010 including description, claims, drawings, and abstract are incorporated herein by reference in its entirety.

Although various exemplary embodiments have been shown and described, the disclosed subject matter is not limited to the embodiments shown. Therefore, the scope of the invention is intended to be limited solely by the scope of the claims that follow.

1. A method for manufacturing a vehicle lighting part, the method using a mold including a fixed section, a movable section, and a core section to slide according to a movement of the movable section, and an injection molding unit to inject a predetermined molding compound into the mold, the method comprising:
putting a first mixture of the molding compound and a chemical foaming agent into the injection molding unit, the molding compound containing polypropylene series resin to which a predetermined amount of talc is added;
producing a second mixture by enclosing a physical foaming agent in the first mixture in the injection molding unit;
injecting the second mixture from the injection molding unit into the mold to fill the mold; and
performing a core back of the core section immediately after injecting the second mixture into the mold to fill the mold.

2. The method for manufacturing the vehicle lighting part according to claim 1, wherein
a temperature of the movable section and a temperature of the core section are set to be higher than a temperature of the fixed section.

3. The method for manufacturing the vehicle lighting part according to claim 1, wherein
the temperature of the movable section and the temperature of the core section are set to equal to or more than 100° C. and the temperature of the fixed section is set to 30 to 60° C.

4. The method for manufacturing the vehicle lighting part according to claim 1, wherein
a core back amount of the core section is 50 to 66% of an original thickness of the second mixture after being injected into the mold to fill the mold.

5. The method for manufacturing the vehicle lighting part according to claim 1, wherein
a length of time, for which the second mixture is injected into the mold to fill the mold, is within 1.1 seconds.

6. A method for manufacturing a vehicle lighting part, comprising:
putting a first mixture of a molding compound and a chemical foaming agent into an injection molding unit, the molding compound containing polypropylene series resin to which a predetermined amount of talc is added;
producing a second mixture by enclosing a physical foaming agent in the first mixture in the injection molding unit;
injecting the second mixture from the injection molding unit into a mold to fill the mold, the mold including a fixed section, a movable section, and a core section to slide according to a movement of the movable section; and
performing a core back of the core section immediately after injecting the second mixture into the mold to fill the mold.
